(19) United States
(12) Patent Application Publication
(10) Pub. No.: US 2025/0131005 A1
(43) Pub. Date: Apr. 24, 2025

(54) DATA PROCESSING METHOD AND APPARATUS BASED ON DATA LAKE AND DATA WAREHOUSE INTEGRATION, AND ELECTRONIC DEVICE

(71) Applicant: Beijing Volcano Engine Technology Co., Ltd., Beijing (CN)

(72) Inventors: Kejian JU, Beijing (CN); Leilei HU, Beijing (CN); Junling DU, Beijing (CN)

(21) Appl. No.: 18/885,559

(22) Filed: Sep. 13, 2024

(30) Foreign Application Priority Data
Oct. 24, 2023 (CN) 202311387765.0

(51) Int. Cl. G06F 16/25

(52) U.S. Cl. CPC G06F 16/254

(57) ABSTRACT

Embodiments of the present disclosure provide a data processing method, apparatus based on data Lake and data Warehouse integration, and an electronic device. The method includes: pre-storing at least two protocol files; receiving a first metadata acquisition request; determining a target protocol file for processing the first metadata acquisition request from the at least two protocol files according to an engine type of the data processing engine which sends the first metadata acquisition request; and parsing, based on the target protocol file, the first metadata acquisition request and acquiring metadata corresponding to the first metadata acquisition request from the metadata storage space. Therefore, for at least two sets of external protocols, one set of metadata is stored, accordingly, the data storage capacity can be reduced; with the setting of one set of metadata, the metadata accessing rights management can be unified, and the security of data can be improved.

### CROSS-REFERENCE TO RELATED APPLICATIONS

This application claims the priority to and benefits of the Chinese Patent Application, No. 202311387765.0, which was filed on Oct. 24, 2023. The aforementioned patent application is hereby incorporated by reference in their entireties.

### TECHNICAL FIELD

The present disclosure relates to the technical field of computers, and in particular to a data processing method and apparatus based on data Lake and data Warehouse integration, and an electronic device.

### BACKGROUND

With the development of information technology, there are more and more application scenarios based on data Lake. In fact, for the user to query data, there may be a large number of data query tasks or query services that require fast response and low data volume to meet user data query needs. However, due to the defects of data query solutions, the data query experience of the user is poor.

### SUMMARY

The present section is provided to introduce concepts in a simplified form, which will be described in detail in the detailed description section later. The present section is not intended to identify key features or essential features of the claimed technical solution, nor is it intended to limit the scope of the claimed technical solution.

In a first aspect, the present disclosure provides a data processing method based on data Lake and data Warehouse integration, which includes: pre-storing at least two protocol files, wherein each protocol file corresponds to a different data processing engine, and the protocol file is used for parsing a metadata acquisition request sent by a corresponding data processing engine and acquiring metadata from a metadata storage space; receiving a first metadata acquisition request sent by a data processing engine; determining a target protocol file for processing the first metadata acquisition request from the at least two protocol files according to an engine type of the data processing engine which sends the first metadata acquisition request; and parsing, based on the target protocol file, the first metadata acquisition request and acquiring metadata corresponding to the first metadata acquisition request from the metadata storage space.

In a second aspect, the present disclosure provides a data processing apparatus based on data Lake and data Warehouse integration, which includes: a storage unit configured to pre-store at least two protocol files, where each protocol file corresponds to a different data processing engine, and the protocol file is used for parsing a metadata acquisition request sent by a corresponding data processing engine and acquiring metadata from a metadata storage space; a receiving unit configured to receive a first metadata acquisition request sent by a data processing engine; a determining unit configured to determine a target protocol file for processing the first metadata acquisition request from the at least two protocol files according to an engine type of the data processing engine which sends the first metadata acquisition request; and a parsing unit configured to parse, based on the target protocol file, the first metadata acquisition request and acquire metadata corresponding to the first metadata acquisition request from the metadata storage space.

In a third aspect, the present disclosure provides an electronic device, which includes: one or more processors, and a storage apparatus configured to store one or more programs, and the one or more programs, when executed by the one or more processors, cause the one or more processors to implement the data processing method based on data Lake and data Warehouse integration according to the first aspect.

In a fourth aspect, the present disclosure provides a computer-readable medium having a computer program stored thereon, the computer program, when executed by a processor, causes the processor to implement the data processing method based on data Lake and data Warehouse integration according to the first aspect.

According to the data processing method and apparatus based on data Lake and data Warehouse integration, and the electronic device provided by the present disclosure, in a scenario where two data processing engines are combined, one set of metadata is stored, and at least two protocol files are pre-stored, where each protocol file corresponds to a different data processing engine, and the protocol file is used for parsing a metadata acquisition request sent by a corresponding data processing engine and acquiring metadata from a metadata storage space; a first metadata acquisition request sent by a data processing engine is received; a target protocol file for processing the first metadata acquisition request is determined from the at least two protocol files according to an engine type of the data processing engine sending the first metadata acquisition request; based on the target protocol file, the first metadata acquisition request is parsed and the metadata corresponding to the first metadata acquisition request is acquired from the metadata storage space. Therefore, for at least two sets of external protocols, one set of metadata is stored, accordingly, the data storage capacity can be reduced; and, with the setting of one set of metadata, the metadata accessing rights management can be unified, and the security of data can be improved.

### BRIEF DESCRIPTION OF DRAWINGS

The above and other features, advantages, and aspects of embodiments of the present disclosure will become more apparent from the following detailed description when taken in conjunction with the accompanying drawings. Throughout the drawings, the same or similar reference numbers refer to the same or similar elements. It should be understood that the drawings are schematic and that components and elements are not necessarily drawn to scale.

FIG. 1 is a flowchart of a data processing method based on data Lake and data Warehouse integration according to the present disclosure;

FIG. 2 is a flowchart of one implementation of a data processing method based on data Lake and data Warehouse integration according to the present disclosure;

FIG. 3 and FIG. 4 are schematic diagrams of application scenarios of a data processing method based on data Lake and data Warehouse integration according to the present disclosure;

FIG. 5 is a schematic structural diagram of a data processing apparatus according to the present disclosure;

FIG. 6 is an exemplary system architecture to which the data processing method based on data Lake and data Warehouse integration according to embodiments of the present disclosure can be applied; and

FIG. 7 is a schematic diagram of a basic structure of an electronic device provided according to embodiments of the present disclosure.

### DETAILED DESCRIPTION

The embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein. Instead, these embodiments are provided for a more thorough and complete understanding of the present disclosure. It should be understood that the drawings and embodiments disclosed herein are for illustrative purposes only and are not intended to limit the scope of protection of the present disclosure.

It should be understood that the various steps described in the disclosed method embodiments may be executed in different orders and/or in parallel. In addition, the method implementation may include additional steps and/or omit the steps shown. The scope of this disclosure is not limited in this regard.

The term “including” and its variations used herein are open-ended, meaning “including but not limited to”. The term “based on” means “based at least in part”. The term “one embodiment” means “at least one embodiment”. The term “another embodiment” means “at least one further embodiment”. The term “some embodiments” means “at least some embodiments”. The relevant definitions of other terms will be provided in the following description.

It should be noted that the concepts such as “first” and “second” mentioned herein are only used to distinguish different devices, modules, or units, and are not intended to limit the order or interdependence of the functions performed by these devices, modules, or units.

It should be noted that the modifications of “one” and “multiple” mentioned herein are illustrative rather than restrictive, and those skilled in the art should understand that unless otherwise explicitly stated in the context, they should be understood as “one or more”.

The names of messages or information exchanged between apparatuses in the embodiments of the present disclosure are for illustrative purposes only, and are not intended to limit the scope of the messages or information.

In one or more embodiments of the present disclosure, the OLAP database (such as Doris, StarRocks, Clickhouse, etc.) is mainly oriented to the scene analysis of a real-time data Warehouse, and the big data processing engine (such as Hive/Spark/Presto, etc., where the present disclosure takes Spark as an example) is mainly oriented to the processing and analysis of offline batch data. Since OLAP is often based on a memory-type MPP architecture, OLAP has higher performance than Spark. However, when processing a large number of data, the OLAP database often faces the stability problem. Therefore, the OLAP database and the big data processing engine may be integrated. However, with the integration of two systems, such as connecting Spark to the OLAP database, the operational and maintenance cost will be higher, and both data and metadata will face the problem of multiple copies. The present disclosure mainly describes the ability of achieving data Lake and data Warehouse integration (also named as “data Lakehouse”) by combining the real-time ability of OLAP and the off-line processing ability of Spark and ensuring that only one copy of data and metadata is stored in a unified manner.

In one or more embodiments of the present disclosure, an OLAP database may include a database front end (FE) and a database back end (BE). In a scenario of connecting Spark to the OLAP database, the FE of the OLAP database may include an access layer which is responsible for receiving and parsing query statements and then sending the query statements to a corresponding data processing engine, that is, a data processing engine corresponding to OLAP or a data processing engine corresponding to Spark; the BE of the OLAP database may include an execution layer and a storage layer of the database, which is used to store a fact table of the database.

In one or more embodiments of the present disclosure, types of request statements (such as a metadata acquisition request) sent by a client to the FE of a server are divided into two types: a simple query with a fast query response and la ow data volume, and a complex query with large-scale ETL and a high data volume. When the type of the request statement sent by the client to the FE of the server is the simple query, a query request is processed based on an OLAP data processing engine; and the OLAP data processing engine requests to acquire corresponding metadata from a metadata storage space through a Mysql protocol file. When the type of the request statement sent by the client to the FE of the server is the complex query, a data query request is processed based on a Spark data processing engine; and the Spark data processing engine requests to acquire the corresponding metadata from the metadata storage space through the protocol file compatible with HiveMetastore.

In one or more embodiments of the present disclosure, since the Spark engine needs to authenticate a user when interacting with the OLAP database, an authentication plug-in may be installed on a Spark client in advance. In a process of authenticating the client, the authentication plug-in sends predefined verification information, such as a user identification, a query request identification, token validity period and a verification code bound to an electronic device, then the authentication plug-in at the FE returns a token to the client, and finally the client returns the token, an interface request (such as getTable), authority information and other information to the FE to complete an authentication operation.

In one or more embodiments of the present disclosure, an access mechanism compatible with an HMS protocol is provided in an OLAP system to ensure that hadoop systems such as Hive, Spark, Presto, etc. can be conveniently compatible with metadata of the OLAP system. It can be understood that OLAP and Spark are taken as examples in the present disclosure, but in an actual application scenario, any multiple data processing engines may be combined.

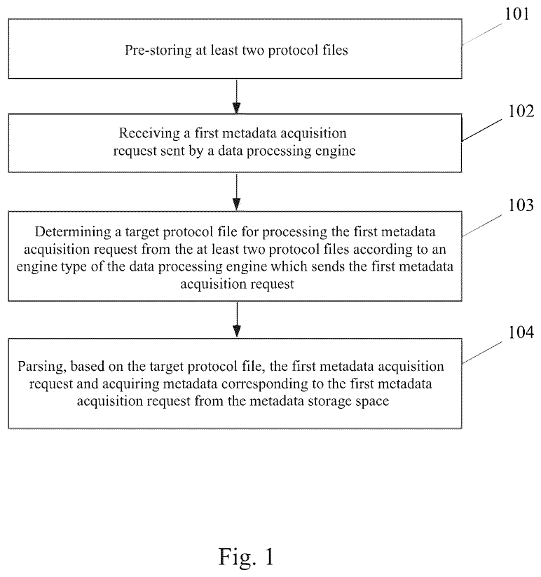

Referring to FIG. 1, it shows a flowchart of a data processing method based on data Lake and data Warehouse integration according to embodiments of the present disclosure. As shown in FIG. 1, the data processing method based on data Lake and data Warehouse integration includes the following steps:

Step 101, pre-storing at least two protocol files.

Here, each protocol file corresponds to a different data processing engine, and the protocol file is used for parsing a metadata acquisition request sent by a corresponding data processing engine and acquiring metadata from a metadata storage space.

Optionally, the protocol file corresponds to the data processing engine one by one; or, one protocol file may correspond to multiple data processing engines, that is, one protocol file can be compatible with multiple data processing engines.

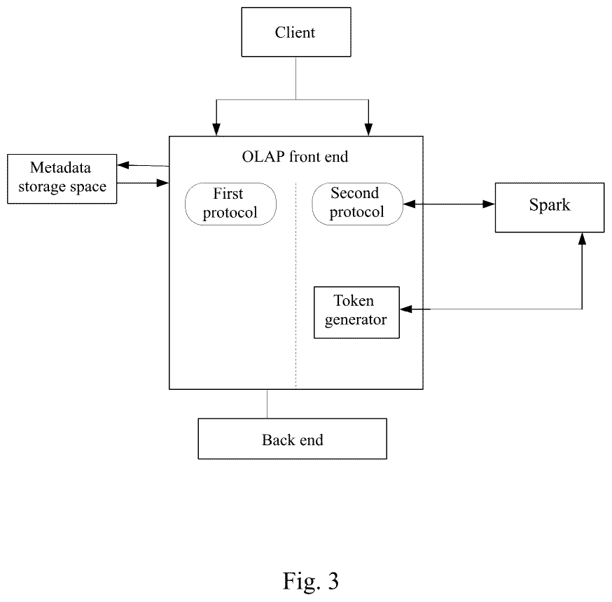

As an example, as shown in FIG. 3, a first protocol and a second protocol are stored at the FE of OLAP, such as the Mysql protocol and a HiveMetastore-compatible protocol (also called an HiveMetastore protocol), the Mysql protocol corresponds to the OLAP data processing engine, and the HiveMetastore protocol corresponds to the Spark data processing engine. The Mysql protocol file is used for parsing the metadata acquisition request corresponding to the OLAP data processing engine and acquiring metadata from the metadata storage space Meta Manager. The HiveMetastore protocol file is used for parsing the metadata acquisition request corresponding to the Spark data processing engine and acquiring metadata from the metadata storage space Meta Manager.

Step 102: receiving a first metadata acquisition request sent by a data processing engine.

As an example, as shown in FIG. 3, the first metadata acquisition request from the OLAP data engine or the Spark data engine to the metadata storage space Meta Manager is received at the FE. Nodes in the OLAP data processing engine, which are used to parse SQL statements to generate a metadata acquisition request, are located in the FE and are not shown in the figure.

Step 103: determining a target protocol file for processing the first metadata acquisition request from the at least two protocol files according to an engine type of the data processing engine which sends the first metadata acquisition request.

As an example, if the engine type of the data processing engine sending the first metadata acquisition request is the OLAP data engine, it is determined that the target protocol file for processing the metadata acquisition request is the Mysql protocol file among the Mysql protocol file and the HiveMetastore protocol file. Correspondingly, if the engine type of the data processing engine sending the first metadata acquisition request is the Spark data engine, it is determined that the target protocol file for processing the metadata acquisition request is the Mysql protocol file among the Mysql protocol file and the HiveMetastore protocol file.

Step 104: parsing, based on the target protocol file, the first metadata acquisition request and acquiring metadata corresponding to the first metadata acquisition request from the metadata storage space.

As an example, as shown in FIG. 3, based on the fact that the target protocol file is the Mysql protocol file or the HiveMetastore protocol file, the first metadata acquisition request is parsed and the metadata corresponding to the first metadata acquisition request is acquired from the metadata storage space. If the target protocol file is the Mysql protocol file, after the first metadata acquisition request is parsed, the metadata corresponding to the first metadata acquisition request is acquired from the metadata storage space Meta Manager via the BE. If the target protocol file is the HiveMetastore protocol file, after the first metadata acquisition request is parsed, the metadata corresponding to the first metadata acquisition request is acquired from the metadata storage space Meta Manager.

It should be noted that in the data processing method based on data Lake and data Warehouse integration provided by the embodiments, in a scenario where two data processing engines are combined, only one set of metadata is stored, and at least two protocol files are pre-stored, where each protocol file corresponds to a different data processing engine, and the protocol file is used for parsing the metadata acquisition request sent by the corresponding data processing engine and acquiring metadata from the metadata storage space; the first metadata acquisition request sent by the data processing engine is received; the target protocol file for processing the first metadata acquisition request is determined from the at least two protocol files according to the engine type of the data processing engine sending the first metadata acquisition request; based on the target protocol file, the first metadata acquisition request is parsed and the metadata corresponding to the first metadata acquisition request is acquired from the metadata storage space. Therefore, for at least two sets of external protocols, one set of metadata is stored, accordingly, the data storage capacity can be reduced; and, with the setting of one set of metadata, the metadata accessing rights management can be unified, and the security of data can be improved.

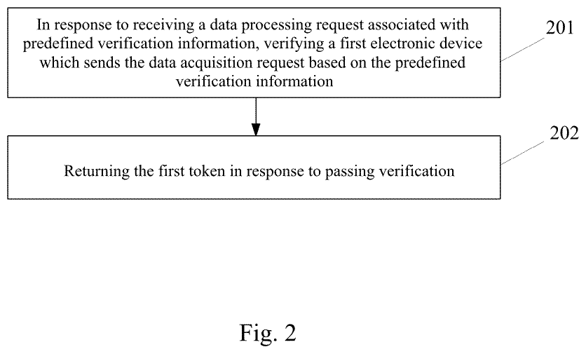

In some embodiments, since user authentication verifying is needed for the Spark engine interacting with the OLAP database, an authentication plug-in may be installed on a Spark client in advance. The process of authenticating the Spark client can be as shown in steps as shown in FIG. 2.

Step 201: in response to receiving a data processing request associated with predefined verification information, verifying a first electronic device which sends the data acquisition request based on the predefined verification information.

The first electronic device may be, for example, a Spark client.

As an example, referring to FIG. 4, in response to receiving a data processing request associated with predefined verification information sent from the Spark engine, the FE verifies the first electronic device which sends the data acquisition request based on the predefined verification information. The first electronic device is a client including the Spark engine. The predefined verification information includes at least one selected from the group of a user identification (UserID), a token duration (token ttl), a verification code (private keys) bound to the first electronic device, and a query identification (queryID). As an example, queryID is mainly used to verify a query, UserID is a user who submits the query, token ttl is mainly used to ensure that a token has an expiration time when the token is maliciously acquired, and machine-bound primary keys are mainly used to ensure that a source of the query is a manageable machine on the cloud.

Step 202: returning the first token in response to passing verification.

As an example, referring to FIG. 4, the FE returns the first token to the Spark client in response to the predefined verification information sent from the first electronic device being verified as successful.

The first electronic device sends the first metadata acquisition request bound to the first token in response to receiving the first token.

Specifically, referring to FIG. 4, the client including the Spark engine sends the first token, the interface request (getTable) and authority information (checkPrivilege) bound to the first token to the FE.

The first electronic device is preset with an authentication plug-in, and the authentication plug-in is used for associating the predefined verification information with the data processing request and sending the data processing request when receiving an instruction to send the data processing request.

Correspondingly, the server is preset with a verification plug-in, and the verification plug-in is used for verifying the data processing request when receiving the data processing request sent by the authentication plug-in.

In some embodiments, the metadata storage space is located outside a front end of a database.

It should be noted that the metadata management originally built in the FE is externally placed in the storage space outside the FE to solve a restrictive relationship of the FE from a master-slave node. Therefore, information with a status may be saved outside the master-slave node of the FE, the query request does not need to be bound to the FE, and is free from limitation from the single performance of the FE in a high-frequency operation scenario (such as an insertion or updating operation), and the operation efficiency is improved.

In some embodiments, the method further includes: in response to receiving a first query request sent by a client, determining a target data processing engine for processing the first query request from at least two data processing engines; and sending the first query request to the target data processing engine, where the target data processing engine generates the first metadata acquisition request in a process of parsing the first query request.

In some embodiments, the target processing engine queries target data corresponding to the first query request from the fact table of the database based on the acquired metadata.

As an example, when the user submits one Spark SQL by the client, the FE will submit one SparkSQL request. Accordingly, the Spark client receives the SQL statement, and it is necessary to acquire metadata when analyzing by an analyzer. The metadata of the table may be acquired through the HiveMetadata protocol, providing that authentication and login are performed.

Metadata authentication provided by the present disclosure is authentication based on a token, not a super administrator authentication method. This token authentication method needs to be integrated into the code of the user. Therefore, this authentication method can avoid a situation that the user cannot perform account authentication by using a super administrator account, and ensure the link security through the user-defined authentication method. The Spark authentication of an open source is local authentication with relatively low security. The user can modify the code content when customizing a jar package, thus this solution adopts authentication by a server.

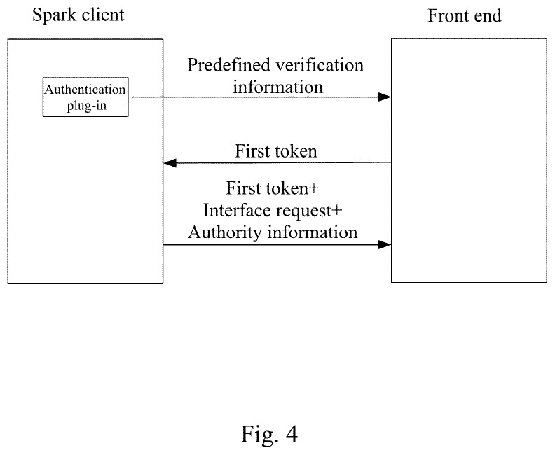

Further referring to FIG. 5, as an implementation of the methods shown in the above figures, embodiments of the present disclosure provide a data processing apparatus based on data Lake and data Warehouse integration, which corresponds to the method embodiments shown in FIG. 1. This apparatus can be specifically applied to various electronic devices.

As shown in FIG. 5, the data processing apparatus based on data Lake and data Warehouse integration in the embodiments includes: a storage unit 501 configured to pre-store at least two protocol files, where each protocol file corresponds to a different data processing engine, and the protocol file is used for parsing a metadata acquisition request sent by the corresponding data processing engine and acquiring metadata from a metadata storage space; a receiving unit 502 configured to receive a first metadata acquisition request sent by the data processing engine; a determining unit 503 configured to determine a target protocol file for processing the first metadata acquisition request from the at least two protocol files according to an engine type of the data processing engine which sends the first metadata acquisition request; and a parsing unit 504 configured to parse, based on the target protocol file, the first metadata acquisition request and acquire metadata corresponding to the first metadata acquisition request from the metadata storage space.

In the embodiments, specific processing of the storage unit 501, the receiving unit 502, the determining unit 503 and the parsing unit 504 of the data processing apparatus based on data Lake and data Warehouse integration and the technical effects brought by them may refer to related descriptions of steps 101, 102, 103 and 104 in the corresponding embodiments of FIG. 1 respectively, and are omitted here.

In some embodiments, the first metadata acquisition request is bound to a first token; and the apparatus is also configured to: in response to receiving a data processing request associated with predefined verification information, verify a first electronic device which sends the data acquisition request based on the predefined verification information; return the first token in response to passing verification; and send, by the first electronic device, the first metadata acquisition request bound to the first token in response to receiving the first token.

In some embodiments, the predefined verification information includes at least one selected from the group of: a user identification, a token duration, and a verification code bound to the first electronic device.

In some embodiments, the first electronic device is preset with an authentication plug-in, and the authentication plug-in is used for, in response to receiving an instruction to send the data processing request, associating the predefined verification information with the data processing request and sending the data processing request.

In some embodiments, the metadata storage space is located outside a front end of a database.

In some embodiments, the apparatus is further configured to: in response to receiving a first query request sent by a client, determine a target data processing engine for processing the first query request from at least two data processing engines; and send the first query request to the target data processing engine, wherein the target data processing engine generates the first metadata acquisition request in a process of parsing the first query request.

In some embodiments, the target processing engine queries target data corresponding to the first query request from the fact table of the database based on the acquired metadata.

Therefore, it is possible to achieve the lake and warehouse integration by combining the real-time ability of OLAP and the off-line processing ability of Spark and ensuring that only one copy of data and metadata is stored in a unified manner.

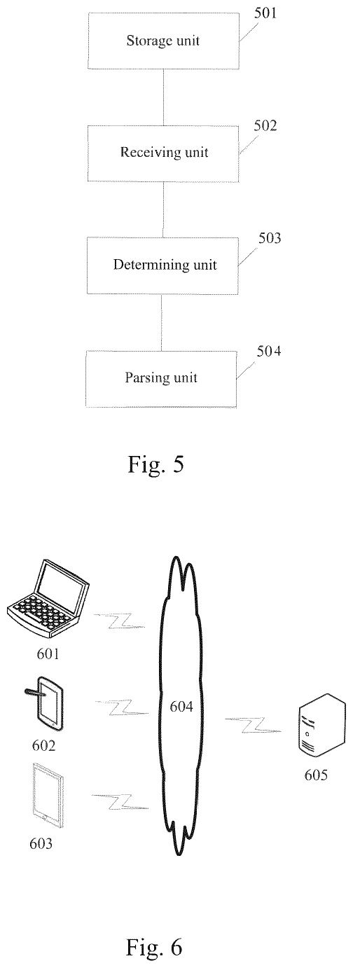

Referring to FIG. 6, FIG. 6 shows an exemplary system architecture to which the data processing method based on data Lake and data Warehouse integration according to embodiments of the present disclosure can be applied.

As shown in FIG. 6, the system architecture may include terminal devices 601, 602 and 603, a network 604 and a server 605. The network 604 is a medium for providing communication links between the terminal devices 601, 602 and 603 and the server 605. The network 604 may include various connection types, such as wired, wireless communication links or fiber optic cables.

The terminal devices 601, 602, and 603 may interact with the server 605 through the network 604 to receive or send messages, etc. Various client applications may be installed on the terminal devices 601, 602 and 603, such as a web browser application, a search application and a news information application. The client applications in the terminal devices 601, 602, and 603 can receive user's instructions and complete corresponding functions according to the user's instructions, such as adding corresponding information to information according to the user's instructions.

The terminal devices 601, 602 and 603 may be hardware or software. When the terminal devices 601, 602, and 603 are hardware, they may be various electronic devices with display screens and supporting web browsing, including but not limited to smart phones, tablet computers, e-book readers, MP3 players (moving picture experts group audio layer III), MP4 players (moving picture experts group audio layer IV), laptop computers, desktop computers and so on. When the terminal devices 601, 602 and 603 are software, they may be installed in the electronic devices listed above. The terminal devices may be implemented as multiple software or software modules (for example, to provide distributed services) or as a single software or software module. It is not specifically limited here.

The server 605 may be a server providing various services, such as receiving information acquisition requests sent by the terminal devices 601, 602, and 603, and acquiring display information corresponding to the information acquisition requests through various ways according to the information acquisition requests. Relevant data of the display information is sent to the terminal devices 601, 602 and 603.

It should be noted that the data processing method based on data Lake and data Warehouse integration provided by the embodiments of the present disclosure can be executed by the terminal device, and correspondingly, the data processing apparatus based on data Lake and data Warehouse integration can be provided in terminal devices 601, 602 and 603. In addition, the data processing method based on data Lake and data Warehouse integration provided by the embodiments of the present disclosure can also be executed by the server 605, and correspondingly, the data processing apparatus based on data Lake and data Warehouse integration can be provided in the server 605.

It should be understood that the numbers of terminal devices, networks and servers in FIG. 6 are only for illustration. According to implementation needs, there may be any number of terminal devices, networks and servers.

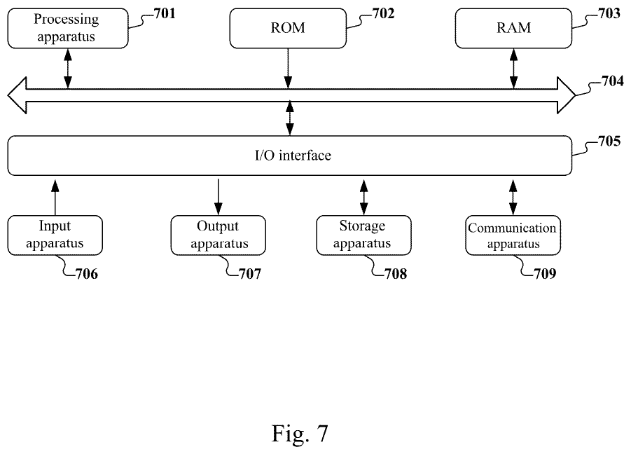

Reference is now made to FIG. 7, which shows a structural schematic diagram of an electronic device (for example, a terminal device or a server in FIG. 6) suitable for implementing embodiments of the present disclosure. The terminal devices in the embodiments of the present disclosure may include, but not limited to, mobile terminals such as a mobile phone, a notebook computer, a digital broadcast receiver, a personal digital assistant (PDA), a tablet computer (PAD), a portable multimedia player (PMP), a vehicle-mounted terminal (for example, a vehicle-mounted navigation terminal) and the like, and fixed terminals such as a digital TV, a desktop computer and the like. The electronic device shown in FIG. 7 is only an example, and should not bring any limitation to the functions and application scope of the embodiments of the present disclosure.

As shown in FIG. 7, the electronic device may include a processing apparatus (for example, a central processing unit, a graphics processing unit, etc.) 701, which may perform various appropriate actions and processes according to programs stored in a read-only memory (ROM) 702 or programs loaded from a storage apparatus 708 into a random-access memory (RAM) 703. In the RAM 703, various programs and data required for operations of the electronic device 700 are also stored. The processing apparatus 701, the ROM 702 and the RAM 703 are connected to each other through a bus 704. An input/output (I/O) interface 705 is also connected to the bus 704.

Generally, the following apparatuses may be connected to the I/O interface 705: an input apparatus 706 including, for example, a touch screen, a touch pad, a keyboard, a mouse, a camera, a microphone, an accelerometer, a gyroscope, etc.; an output apparatus 707 including, for example, a liquid crystal display (LCD), a speaker, a vibrator, etc.; a storage apparatus 708 including, for example, a magnetic tape, a hard disk, etc.; and a communication apparatus 709. The communication apparatus 709 may allow the electronic device to perform wireless or wired communication with other devices to exchange data. While the electronic device with various apparatuses is shown in FIG. 7, it should be understood that it is not required to implement or have all the apparatuses shown. More or fewer apparatuses may alternatively be implemented or provided.

In particular, according to the embodiments of the present disclosure, processes described above with reference to the flowchart may be implemented as a computer software program. For example, embodiments of the present disclosure include a computer program product, which includes a computer program carried on a non-transitory computer-readable medium, the computer program including program codes for performing the method shown in the flowchart. In such embodiments, the computer program may be downloaded and installed from a network through the communication apparatus 709, or installed from the storage apparatus 708, or installed from the ROM 702. When the computer program is executed by the processing apparatus 701, the above functions defined in the method of the embodiment of the present disclosure are performed.

It should be noted that the computer-readable medium mentioned above in the present disclosure may be a computer-readable signal medium or a computer-readable storage medium or any combination of both. The computer-readable storage medium may be, for example, but not limited to, an electrical, magnetic, optical, electromagnetic, infrared, or semiconductor system, apparatus or device, or a combination of any of the above. More specific examples of the computer-readable storage medium may include, but not limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program, which program may be used by or in combination with an instruction execution system, apparatus or device. In the present disclosure, the computer-readable signal medium may include a data signal propagated in a baseband or as part of a carrier wave, in which computer-readable program codes are carried. This propagated data signal may take multiple forms, including but not limited to electromagnetic signals, optical signals or any suitable combination of the above. The computer-readable signal medium may also be any computer-readable medium other than the computer-readable storage medium, and may send, propagate or transmit a program used by or in combination with an instruction execution system, apparatus or device. The program codes contained in the computer-readable medium may be transmitted by any suitable medium, including but not limited to: electric wires, optical cables, radio frequency (RF) and the like, or any suitable combination of the above.

In some implementations, the client and the server can communicate by using any currently known or future developed network protocol such as a hypertext transfer protocol (HTTP), and may be interconnected with digital data communication in any form or medium (for example, a communication network). Examples of the communication network include a local area network (LAN), a wide area network (WAN), the Internet work (for example, the Internet) and an end-to-end network (for example, an ad hoc end-to-end network), as well as any currently known or future developed networks.

The computer-readable medium may be included in the electronic device; or it may exist alone without being assembled into the electronic device.

The computer-readable medium carries one or more programs which, when executed by the electronic device, cause the electronic device to: pre-store at least two protocol files, where each protocol file corresponds to a different data processing engine, and the protocol file is used for parsing a metadata acquisition request sent by the corresponding data processing engine and acquiring metadata from a metadata storage space; receive a first metadata acquisition request sent by the data processing engine; determine a target protocol file for processing the first metadata acquisition request from the at least two protocol files according to an engine type of the data processing engine which sends the first metadata acquisition request; and parse, based on the target protocol file, the first metadata acquisition request and acquire metadata corresponding to the first metadata acquisition request from the metadata storage space.

Computer program code for performing the operations disclosed herein may be written in one or more programming languages or combinations thereof, including but not limited to object-oriented programming languages such as Java, Smalltalk, C++, as well as conventional procedural programming languages such as “C” language or similar programming languages. Program code can be executed entirely on the user's computer, partially on the user's computer, as a standalone software package, partially on the user's computer, partially on a remote computer, or entirely on a remote computer or server. In cases involving remote computers, the remote computer can be connected to the user's computer through any type of network, including a local area network (LAN) or a wide area network (WAN), or can be connected to an external computer (such as using an internet service provider to connect via the internet).

The flowchart and block diagram in the attached figure illustrate the possible implementation architecture, functions, and operations of the system, method, and computer program product according to various embodiments of the present disclosure. In this regard, each box in a flowchart or block diagram can represent a module, program segment, or part of code that contains one or more executable instructions for implementing specified logical functions. It should also be noted that in some alternative implementations, the functions marked in the boxes may occur in a different order than those marked in the figures. For example, two consecutive boxes can actually be executed in parallel, and sometimes they can also be executed in reverse order, depending on the functions involved. It should also be noted that each box in the block diagram and/or flowchart, as well as combinations of boxes in the block diagram and/or flowchart, can be implemented using dedicated hardware-based systems that perform specified functions or operations, or can be implemented using a combination of dedicated hardware and computer instructions.

The units described in this disclosed embodiment can be implemented through software or hardware. Among them, the name of the unit does not constitute a limitation on the unit itself in some cases, for example, the receiving unit can also be described as the “unit that receives requests”. The functions described above in this article can be at least partially executed by one or more hardware logic components. For example, non-limiting exemplary types of hardware logic components that can be used include: Field Programmable Gate Arrays (FPGAs), Application Specific Integrated Circuits (ASICs), Application Specific Standard Products (ASSPs), System on Chip (SOC), Complex Programmable Logic Devices (CPLDs), and so on.

In the context of this disclosure, a machine-readable medium may be a tangible medium that contains or stores programs for use by or in combination with an instruction execution system, apparatus, or device. Machine readable media can be machine readable signal media or machine-readable storage media. Machine readable media may include, but are not limited to, electronic, magnetic, optical, electromagnetic, infrared, or semiconductor systems, devices, or equipment, or any suitable combination of the above. More specific examples of machine-readable storage media include electrical connections based on one or more wires, portable computer disks, hard drives, random access memory (RAM), read-only memory (ROM), erasable programmable read-only memory (EPROM or flash memory), optical fibers, compact disc read-only memory (CD-ROM), optical storage devices, magnetic storage devices, or any suitable combination of the above.

The above description is only a preferred embodiment of the present disclosure and an explanation of the technical principles applied. Technicians in this field should understand that the scope of disclosure referred to in this disclosure is not limited to technical solutions formed by specific combinations of the above technical features, and should also cover other technical solutions formed by arbitrary combinations of the above technical features or their equivalent features without departing from the above disclosed concept. For example, a technical solution formed by replacing the above features with (but not limited to) technical features with similar functions disclosed in this disclosure.

In addition, although the operations are depicted in a specific order, this should not be understood as requiring these operations to be executed in the specific order shown or in a sequential order. Under certain circumstances, multitasking and parallel processing may be advantageous. Similarly, although several specific implementation details are included in the above discussion, they should not be interpreted as limiting the scope of this disclosure. Certain features described in the context of individual embodiments can also be combined and implemented in a single embodiment. On the contrary, various features described in the context of a single embodiment can also be implemented individually or in any suitable sub-combination in multiple embodiments.

Although the subject matter has been described using language specific to structural features and/or method logic actions, it should be understood that the subject matter defined in the appended claims is not necessarily limited to the specific features or actions described above. On the contrary, the specific features and actions described above are merely exemplary forms of implementing the claims.

1. A data processing method based on data Lake and data Warehouse integration, comprising:
pre-storing at least two protocol files, wherein each protocol file corresponds to a different data processing engine, and the protocol file is used for parsing a metadata acquisition request sent by a corresponding data processing engine and acquiring metadata from a metadata storage space;
receiving a first metadata acquisition request sent by a data processing engine;
determining a target protocol file for processing the first metadata acquisition request from the at least two protocol files according to an engine type of the data processing engine which sends the first metadata acquisition request; and
parsing, based on the target protocol file, the first metadata acquisition request and acquiring metadata corresponding to the first metadata acquisition request from the metadata storage space.

2. The method of claim 1, wherein the first metadata acquisition request is bound to a first token; and
wherein the method further comprises:
in response to receiving a data processing request associated with predefined verification information, verifying a first electronic device which sends the data acquisition request based on the predefined verification information;
returning the first token in response to passing verification; and
sending, by the first electronic device, the first metadata acquisition request bound to the first token in response to receiving the first token.

3. The method of claim 2, wherein the predefined verification information comprises at least one selected from a group of: a user identification, a token duration, and a verification code bound to the first electronic device.

4. The method of claim 2, wherein the first electronic device is preset with an authentication plug-in, and the authentication plug-in is used for, in response to receiving an instruction to send the data processing request, associating the predefined verification information with the data processing request and sending the data processing request.

5. The method of claim 1, wherein the metadata storage space is located outside a front end of a database.

6. The method of claim 1, further comprising:
in response to receiving a first query request sent by a client, determining a target data processing engine for processing the first query request from at least two data processing engines; and
sending the first query request to the target data processing engine, wherein the target data processing engine generates the first metadata acquisition request in a process of parsing the first query request.

7. The method of claim 6, wherein the target processing engine queries target data corresponding to the first query request from a fact table of a database based on the acquired metadata.

8. An electronic device, comprising:
one or more processors; and
a non-transitory memory configured to store machine-readable instructions,
wherein the machine-readable instructions, when executed by the one or more processors, cause the one or more processors to:
pre-store at least two protocol files, wherein each protocol file corresponds to a different data processing engine, and the protocol file is used for parsing a metadata acquisition request sent by a corresponding data processing engine and acquiring metadata from a metadata storage space;
receive a first metadata acquisition request sent by a data processing engine;
determine a target protocol file for processing the first metadata acquisition request from the at least two protocol files according to an engine type of the data processing engine which sends the first metadata acquisition request; and
parse, based on the target protocol file, the first metadata acquisition request and acquire metadata corresponding to the first metadata acquisition request from the metadata storage space.

9. The electronic device of claim 8, wherein the first metadata acquisition request is bound to a first token; and
wherein the machine-readable instructions further cause the one or more processors to:
in response to receiving a data processing request associated with predefined verification information, verify a first electronic device which sends the data acquisition request based on the predefined verification information;
return the first token in response to passing verification; and
send, by the first electronic device, the first metadata acquisition request bound to the first token in response to receiving the first token.

10. The electronic device of claim 9, wherein the predefined verification information comprises at least one selected from a group of: a user identification, a token duration, and a verification code bound to the first electronic device.

11. The electronic device of claim 9, wherein the first electronic device is preset with an authentication plug-in, and the authentication plug-in is used for, in response to receiving an instruction to send the data processing request, associating the predefined verification information with the data processing request and sending the data processing request.

12. The electronic device of claim 8, wherein the metadata storage space is located outside a front end of a database.

13. The electronic device of claim 8, wherein the machine-readable instructions further cause the one or more processors to:
in response to receiving a first query request sent by a client, determine a target data processing engine for processing the first query request from at least two data processing engines; and
send the first query request to the target data processing engine, wherein the target data processing engine generates the first metadata acquisition request in a process of parsing the first query request.

14. The electronic device of claim 13, wherein the target processing engine queries target data corresponding to the first query request from a fact table of a database based on the acquired metadata.

15. A non-transitory computer-readable storage medium storing instructions that cause a processor to:
pre-store at least two protocol files, wherein each protocol file corresponds to a different data processing engine, and the protocol file is used for parsing a metadata acquisition request sent by a corresponding data processing engine and acquiring metadata from a metadata storage space;
receive a first metadata acquisition request sent by a data processing engine;
determine a target protocol file for processing the first metadata acquisition request from the at least two protocol files according to an engine type of the data processing engine which sends the first metadata acquisition request; and
parse, based on the target protocol file, the first metadata acquisition request and acquire metadata corresponding to the first metadata acquisition request from the metadata storage space.

16. The non-transitory computer-readable storage medium of claim 15, wherein the first metadata acquisition request is bound to a first token; and
wherein the instructions further cause the processor to:
in response to receiving a data processing request associated with predefined verification information, verify a first electronic device which sends the data acquisition request based on the predefined verification information;
return the first token in response to passing verification; and
send, by the first electronic device, the first metadata acquisition request bound to the first token in response to receiving the first token.

17. The non-transitory computer-readable storage medium of claim 16, wherein the predefined verification information comprises at least one selected from a group of:
a user identification, a token duration, and a verification code bound to the first electronic device.

18. The non-transitory computer-readable storage medium of claim 16, wherein the first electronic device is preset with an authentication plug-in, and the authentication plug-in is used for, in response to receiving an instruction to send the data processing request, associating the predefined verification information with the data processing request and sending the data processing request.

19. The non-transitory computer-readable storage medium of claim 15, wherein the metadata storage space is located outside a front end of a database.

20. The non-transitory computer-readable storage medium of claim 15, wherein the instructions further cause the processor to:
in response to receiving a first query request sent by a client, determine a target data processing engine for processing the first query request from at least two data processing engines; and
send the first query request to the target data processing engine, wherein the target data processing engine generates the first metadata acquisition request in a process of parsing the first query request.
